(19) United States
(12) Patent Application Publication
(10) Pub. No.: US 2009/0116567 A1
(43) Pub. Date: May 7, 2009

(54) Channel estimation method and apparatus for long range signals in bluetooth

(75) Inventors: Albert Chen, Hsinchu (TW); Kuang-Ping Ma, Hsinchu (TW)

Correspondence Address: BIRCH STEWART KOLASCH & BIRCH, PO BOX 747, FALLS CHURCH, VA, 22040-0747, US

(73) Assignee: Integrated System Solution Corp.

(21) Appl. No.: 11/979,687

(22) Filed: Nov. 7, 2007

(51) Int. Cl. H04L 27/28

(52) U.S. Cl. 375/260

(57) ABSTRACT

The present invention discloses a channel estimation method for Bluetooth signals through a multipath propagation channel, using a SYNC sequence as a preamble sequence. It mainly comprises the steps of: use of SYNC sequence as input to LS-based channel impulse response estimation, precomputation of local frequency domain preamble, precomputation of local inverted frequency domain preamble and shortening of estimated channel impulse response for further equalization purposes. The proposed channel estimation method and apparatus according to the present invention enables use of efficient equalization algorithms, therefore mitigating ISI and very successfully estimates propagation conditions while being very implementation-friendly.

### BACKGROUND OF THE INVENTION

1. Field of the Invention

The present invention generally relates to a channel estimation method and an apparatus for Bluetooth signals, and more particularly to a channel estimation method and apparatus for long transmission range of Bluetooth signals to mitigate the inter-symbol interference (ISI) introduced by multipath propagation in the long transmission range

2. Description of the Prior Art

Recently, with the rapid advent of information age accompanied with fast development of various communication technologies, industries have taken strong interests in wireless personal area networks (WPAN) such as the so-called Bluetooth and shared wireless access protocol (SWAP). In particular, the Bluetooth system is focused on a low cost, simple hardware and robustness facilitating protected ad-hoc connections for stationary and mobile communication environments. The Bluetooth system has three main application areas: a wire replacement, a local area network (LAN) access point and a personal area network.

It was shown that even for very moderate multipath propagation, no reliable data transmission using Bluetooth technology is possible. That is due to the inter-symbol interference (ISI) introduced by multipath propagation. Current Bluetooth receivers of prior art are not capable of mitigating the unfavorable impact of ISI on the data demodulation in Bluetooth. A solution to the ISI problem is the use of channel equalization technology.

First, a system model for Bluetooth system was introduced. In this model, the received signal r is given by:

r=H·d+n (1)

The following denotation is used:
Block (vector) d of data of length N (any coding, modulation or spreading is assumed to be included in d already)
Channel characterized by its impulse response h (convolution of d and h expressed in matrix notation using matrix H)
n denotes additive white Gaussian noise with zero mean and covariance matrix Rₙₙ

In a prior art, a method for equalization of the ICI introduced by multipath propagation (i.e. channel equalization) was disclosed. Using so-called (block) linear equalization technique, an estimate of the transmit data (i.e. equalized data) is obtained using:

\hat{d}_{MMSE}=(H^{H}·H+σ²)⁻¹·H^{H}·r (2)

The equalization technique described in Error! Reference source not found. is called Minimum Mean Square Error (MMSE) equalization. In order to avoid complex receiver processing tasks such as Cholesky decomposition for solving Equation (2), the equalization is performed efficiently in frequency domain:

$$\begin{matrix}{\hat{d}}_{MMSE} = {F}^{- 1} \{ {H}_{inv} \cdot F ( r ) \} & ( 3 ) \\ and & \\ {H}_{inv} = \frac{{( F \{ \hat{h} \} )}^{*}}{{( F \{ \hat{h} \} )}^{*} \cdot F \{ \hat{h} \} + {σ}^{2}} ( need to be checked ) & ( 4 )\end{matrix}$$

The following denotation is used:
F for Discrete Fourier Transform (DFT)
F⁻¹ for Inverse Discrete Fourier Transform (IDFT)
ĥ refers to the estimated channel impulse response
Hᵢₙᵥ represents the frequency response of the propagation channel being inverted using MMSE criterion
Time-domain equivalent to Hᵢₙᵥ is given by hᵢₙᵥ

In which, ĥ is obtained by a separate processing step typically called channel estimation (CE). In addition, for actual implementations, DFT and IDFT are realized by Fast Fourier Transform (FFT) and Inverse Fast Fourier Transform (IFFT), respectively.

In order to apply any channel equalization method, knowledge on the current multipath propagation conditions is required. Such knowledge is typically acquired by performing channel estimation. However, for Bluetooth technology, there are no suitable and publicly known channel estimation methods known.

In most state-of-the-art wireless communication systems, a known pilot sequence is transmitted to allow the receiver to estimate the current propagation channel conditions. These sequences typically serve as input to channel estimators based on correlation techniques. Correlation-based channel estimators, however, require the pilot sequence to satisfy certain characteristics such as an impulse-like auto-correlation. The Bluetooth system does not provide such a pilot sequence. Therefore, there is needed to provide a novel method and apparatus to effective channel estimation. According to the present invention, multipath propagation channel estimation technology is proposed for Bluetooth data communication. The present invention discloses a new method and apparatus to perform channel estimation for Bluetooth systems precisely and efficiently.

### SUMMARY OF THE DISCLOSURE

The primary objective of the present invention is to provide a channel estimation method for Bluetooth signals through a multipath propagation channel, using a SYNC sequence as a preamble sequence.

The second objective of the present invention is to provide a channel estimation apparatus for Bluetooth signals, through a multipath propagation channel, using a SYNC sequence as a preamble sequence.

In order to achieve the above objectives, the present invention provides a channel estimation method for Bluetooth signals through a multipath propagation channel, using a SYNC sequence as a preamble sequence. It mainly comprises the steps of: (A) converting a local preamble sequence before the SYNC sequence transmitting through the multipath propagation channel to frequency domain by means of Fast Fourier Transform; (B) converting the received preamble sequence after the SYNC sequence transmitting through the multipath propagation channel to frequency domain by means of Fast Fourier Transform; (C) dividing the received frequency domain preamble by the local frequency domain preamble to yield an estimate of the propagation channel frequency response; and (D) converting the estimate of the propagation channel frequency response to time domain by means of Inverse Fast Fourier Transform.

In order to achieve the second objective, the present invention provides a channel estimation apparatus for Bluetooth signals, through a multipath propagation channel, using a SYNC sequence as a preamble sequence. It mainly comprises: (A) means for converting a local preamble sequence before the SYNC sequence transmitting through the multipath propagation channel to frequency domain by means of Fast Fourier Transform; (B) means for converting the received preamble sequence after the SYNC sequence transmitting through the multipath propagation channel to frequency domain by means of Fast Fourier Transform; (C) means for dividing the received frequency domain preamble by the local frequency domain preamble to yield an estimate of the propagation channel frequency response; and (D) means for converting the estimate of the propagation channel frequency response to time domain by means of Inverse Fast Fourier Transform.

It is noted that when the first step (C) is to convert a local inverted preamble sequence before the SYNC sequence transmitting through the multipath propagation channel to frequency domain by means of Fast Fourier Transform, the third step (C) must be changed as to multiplying the received frequency domain preamble with the local inverted frequency domain preamble to yield an estimate of the propagation channel frequency response.

It is also noted that when the first means is used for converting a local inverted preamble sequence before the SYNC sequence transmitting through the multipath propagation channel to frequency domain by means of Fast Fourier Transform, the third means must be changed as to be used for multiplying the received frequency domain preamble with the local inverted frequency domain preamble to yield an estimate of the propagation channel frequency response.

The proposed channel estimation method and apparatus according to the present invention enables use of efficient equalization algorithms, therefore mitigating ISI, and very successfully estimates propagation conditions while being very implementation-friendly.

Therefore, a new technology especially targets the combined use of channel estimation technology a according to the present invention and channel equalization. It must be noted that the new technology is not limited to any type of channel equalization but can be used in combination with numerous other state-of-the-art channel equalization methods.

The invention itself, though conceptually explained in above, can be best understood by referencing to the following description, taken in conjunction with the accompanying drawings.

### BRIEF DESCRIPTION OF THE DRAWINGS

FIG. 1: structure of the general enhanced data rate packet format;

FIG. 2: a flow chart illustrating a channel estimation method for Bluetooth signals of (a) the first embodiment and (b) the second embodiment;

FIG. 3: a functional block diagram illustrating a channel estimation apparatus for Bluetooth signals;

FIG. 4: structure of the synchronization sequence;

FIG. 5: the system model used for the embodiments;

FIG. 6: the bit error rate for 2 Mbps transmission using Pi/4-DQPSK; and

FIG. 7: the bit error rate for 3 Mbps transmission using D8PSK.

### DETAILED DESCRIPTION OF THE PREFERRED EMBODIMENTS

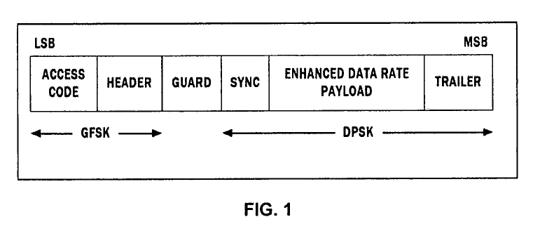

In general, there are known sequences transmitted within a Bluetooth enhanced data rate (EDR) packet such as the ACCESS CODE (not a-priori known but can be re-modulated after detection) or the synchronization (SYNC) sequence (see FIG. 1). These sequences can in principle be used for correlation-based channel estimation. Their non-ideal auto-correlation properties, however, cause very imprecise estimation results.

Now referring to FIG. 1, it is a structure of the general enhanced data rate packet format.

Also, both ACCESS CODE and SYNC do have a pre-guard period which means that no multipath echoes will fall into these sequences from data transmitted before. However, there are no post-guard periods which means that both ACCESS CODE and SYNC will cause inter-symbol interference to the following data.

The SYNC sequence is generated by modulating the 20 bit sequence:
[0,1,1,1,0,1,1,1,0,1,1,1,1,1,0,1,0,1,0,1] by π/4-DQPSK,

or modulating the 30 bit sequence:

[0,1,0,1,1,1,0,1,0,1,1,1,0,1,0,1,1,1,1,1,1,0,1,0,0,1,0,0,1,0] by D8PSK. In both cases, the modulation generates 11 symbols (same for Pi/4-DQPSK and D8PSK):

In the present invention, the SYNC sequence is considered as a preamble sequence such as provided in the OFDM system 802.11a for channel estimation purposes. Using such a preamble sequence, least-square-based channel estimation (LS CE) can be performed.

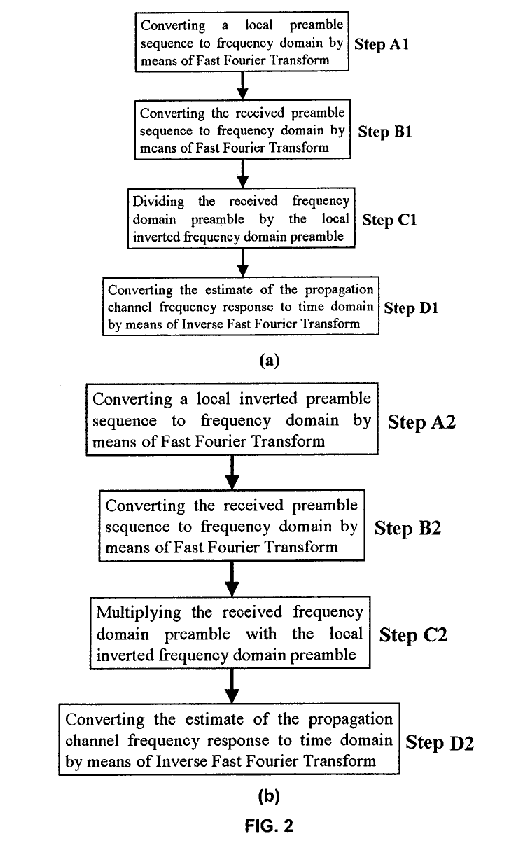

Now, referring to FIG. 2, it is a flow chart illustrating a method for a channel estimation method for Bluetooth signals of (a) the first embodiment and (b) the second embodiment according to the present invention.

In first embodiment as shown in FIG. 2(a), the disclosed channel estimation method for Bluetooth signals through a multipath propagation channel uses a SYNC sequence as a preamble sequence. The method mainly comprises the steps of: (A1) converting a local inverted preamble sequence before the SYNC sequence transmitting through the multipath propagation channel to frequency domain by means of Fast Fourier Transform; (B1) converting the received preamble sequence after the SYNC sequence transmitting through the multipath propagation channel to frequency domain by means of Fast Fourier Transform; (C1) multiplying the received frequency domain preamble with the local inverted frequency domain preamble to yield an estimate of the propagation channel frequency response; and (D1) converting the estimate of the propagation channel frequency response to time domain by means of Inverse Fast Fourier Transform.

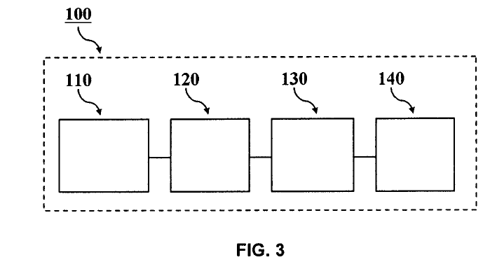

And, referring to FIG. 3, it is a functional block illustrating a channel estimation apparatus for Bluetooth signals according to the present invention. A channel estimation apparatus 100 for Bluetooth signals, through a multipath propagation channel, using a SYNC sequence as a preamble sequence, mainly comprising: first means 110 for converting a local preamble sequence before the SYNC sequence transmitting through the multipath propagation channel to frequency domain by means of Fast Fourier Transform; second means 120 for converting the received preamble sequence after the SYNC sequence transmitting through the multipath propagation channel to frequency domain by means of Fast Fourier Transform; third means 130 for dividing the received frequency domain preamble by the local frequency domain preamble to yield an estimate of the propagation channel frequency response; and fourth means 140 for converting the estimate of the propagation channel frequency response to time domain by means of Inverse Fast Fourier Transform.

For channel equalization, an FFT/IFFT dimension of 16 is prefered which requires a channel estimate of length 8. Therefore, the local time domain preamble of the disclosed channel estimation method is formed by selecting symbol 1 to symbol 8 from the SYNC sequence. Further, the 8-symbol preamble is cyclically rotated by 2 to the index sequence [3, 4, 5, 6, 7, 8, 1, 2].

This final local time domain preamble now also features a cyclic prefix, i.e. symbols 3 and 4 appear to be copies od symbols 1 and 2. That implies that a channel impulse response of a maximum length of 3 taps can be estimated. The local time domain preamble can now be used to perform LS CE as described above. The 8 symbol needed from the received SYNC sequence are extract by choosing symbols indices 3 to 10 (from 1 to 11).

Further improvements to the disclosed channel estimation method are: (i) precompute the conversion to frequency domain of the local time domain preamble using FFT of dimension 8 yielding the local frequency domain preamble; and (ii) precompute the inversion of the local frequency domain preamble which allows to replace the computational expensive division of received preamble by local preamble by a multiplication of received preamble with local preamble.

After the precomputed local frequency domain preamble is given, the estimated impulse response of the multipath propagation channel can be shortened to the expected length of the impulse response, i.e. 1, 2 or 3 taps. That will improve subsequent channel equalization because the 1-3 tap impulse response can be zero-padded to length 16 which improves its signal-to-noise ratio.

In the second embodiment according to the present invention, it is noted that when the first step (A1) is modified to be step (A2) convert a local inverted preamble sequence before the SYNC sequence transmitting through the multipath propagation channel to frequency domain by means of Fast Fourier Transform, the third step (C1) must be changed as step (C2) to multiplying the received frequency domain preamble with the local inverted frequency domain preamble to yield an estimate of the propagation channel frequency response. The process flow is shown in FIG. 2(b).

In the same way, it is also noted that when the first means 110 is used for converting a local inverted preamble sequence before the SYNC sequence transmitting through the multipath propagation channel to frequency domain by means of Fast Fourier Transform, the third means 130 must be changed as to be used for multiplying the received frequency domain preamble with the local inverted frequency domain preamble to yield an estimate of the propagation channel frequency response.

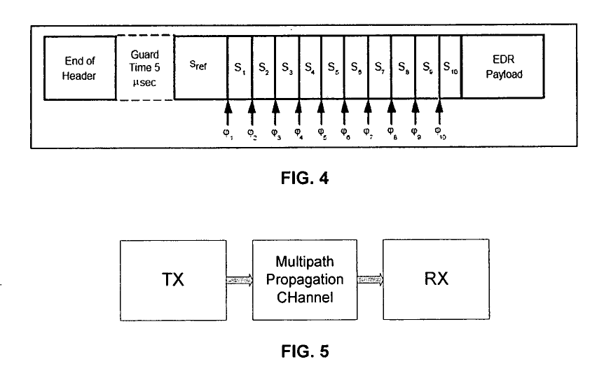

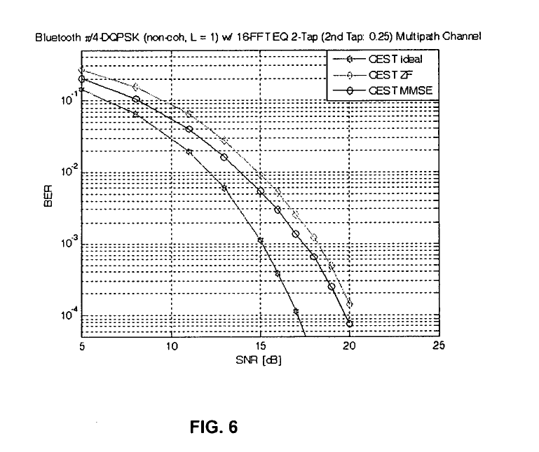

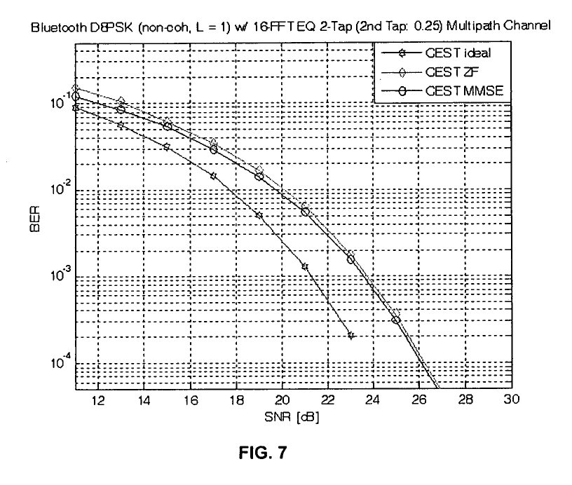

The following section describes more detail process of the second embodiment of the present invention. Referring to FIG. 4, it is a structure of the synchronization sequence. For enhanced data rate packets, the symbol timing at the start of the synchronization (SYNC) sequence shall be within ±¼ μsec of the symbol timing of the last GFSK symbol of the packet header. The length of the synchronization sequence is 11 μsec (11 DPSK symbols) and consists of a reference symbol (with arbitrary phase) followed by ten DPSK symbols. The phase changes between the DPSK symbols (shown in Synchronization sequence) shall be

{φ₁, φ₂, φ₃, φ₄, φ₅, φ₆, φ₇, φ₈, φ₉, φ₁₀}={3π/4, −3π/4, 3π/4, −3π/4, 3π/4, −3π/4, −3π/4, 3π/4, 3π/4, 3π/4} (5)

Where, Sref is the reference symbol. φ1 is the phase change between the reference symbol and the first DPSK symbol S1. φk is the phase change between the k-1th symbol Sk-1 and the kth symbol Sk.

It is noted that the synchronization sequence may be generated using the modulator by pre-pending the data with bits that generate the synchronization sequence. For π/4-DQPSK, the bit sequence used to generate the synchronization sequence is 0,1,1,1,0,1,1,1,0,1,1,1,1,1,0,1,0,1,0,1. For 8DPSK, the bit sequence used to generate the synchronization sequence is 0,1,0,1,1,1,0,1,0,1,1,1,0,1,0,1,1,1,1,1,1,0,1,0,0,1,0,0,1,0.

In a numerical example of the embodiment according to the present invention, the method for a channel estimation method for Bluetooth signals the present invention disclosed above is illustrated for clarification and deeper insight. The system model used for the example is sketched in Error! Reference source not found.5. The embodiment focuses at the transmission of the SYNC sequence through a multipath propagation channel and the channel estimation performed at the receiver using a local inverted preamble according to the present invention.

The entire packet including SYNC sequence is passed through a 2-tap multipath propagation channel. The actual SYNC sequence before transmission (i.e. at transmit side) is given in

Table 2. The 2-tap impulse response of the multipath propagation channel applied is given in

Table 1. The SYNC sequence after transmission (i.e. at transmit side) is given in Table 3.

TABLE 1
Impulse response of multipath propagation channel

0.8398 + 0.3078i
−0.4166 − 0.1626i

The transmission assumes noiseless conditions. Time and frequency synchronization is assumed to be ideal. The first SYNC sequence symbol after transmission is equal to the first tap of the impulse response of the multipath propagation channel. This is due to the guard period inserted in the packet just before the SYNC sequence (see F).

The impulse response of the multipath propagation channel will cause inter-symbol interference from the SYNC sequence towards the EDR payload (see F). That effect is not taken into account within the CE procedure.

TABLE 2
SYNC sequence at transmitter
1.0000
−0.7071 + 0.7071i
1.0000
−0.7071 + 0.7071i
1.0000
−0.7071 + 0.7071i
1.0000
−0.7071 − 0.7071i
1.0000
−0.7071 + 0.7071i
−0.0000 − 1.0000i

TABLE 3
SYNC sequence at receiver
0.8398 + 0.3078i
−1.2281 + 0.2136i
1.2494 + 0.1282i
−1.2281 + 0.2136i
1.2494 + 0.1282i
−1.2281 + 0.2136i
1.2494 + 0.1282i
−0.7928 − 0.9741i
1.0194 + 0.7174i
−1.2281 + 0.2136i
0.7174 − 1.0194i

As disclosed in Step (A2), a pre-computed local inverted preamble is required in order to perform channel estimation according to the present invention. The computation of the local inverted preamble further requires 4 steps of:

(A2-1) selecting 8 out of 11 preamble (time domain) symbols of the SYNC sequency;

(A2-2) reshuffling the selected symbols;

(A2-3) performing an Fast Fourier Transform of dimension 8 on the reshuffled symbols; and

(A2-4) inverting the 8 frequency domain symbols to obtain the local inverted preamble.

Step A2-1 starts with the actual SYNC sequence before transmission (i.e. at transmit side) as given in Table 4. Symbols 1 to 8 (symbols are numbered from 1 to 11) are selected for further use. The selection result is shown in Table 5. In Step A2-2, the 8 selected symbols are reshuffled from indices [1 2 3 4 5 6 7 8] to [3 4 5 6 7 8 1 2]. The resulting sequence is shown in Table 5.

In Step A2-3, the 8 reshuffled symbols are converted to frequency domain by means of an FFT of dimension 8. The resulting sequence is shown in Table 6.

In Step A2-4, the 8 frequency domain symbols are inverted symbol-wise. The resulting sequence is shown in Table 7. This sequence is further used as so-called local inverted preamble. It is assumed to be pre-computed and stored locally in the Bluetooth receiver.

TABLE 4
SYNC sequence at transmitter
1.0000
−0.7071 + 0.7071i
1.0000
−0.7071 + 0.7071i
1.0000
−0.7071 + 0.7071i
1.0000
−0.7071 − 0.7071i
1.0000
−0.7071 + 0.7071i
−0.0000 − 1.0000i

TABLE 5
Steps A2-1 &2 of the pre-computation procedure
1.0000
−0.7071 + 0.7071i
1.0000
−0.7071 + 0.7071i
1.0000
−0.7071 − 0.7071i
1.0000
−0.7071 + 0.7071i

TABLE 6
Step A2-3 of the pre-computation procedure
1.1716 + 1.4142i
1.0000 + 1.0000i
−1.4142
1.0000 − 1.0000i
6.8284 − 1.4142i
−1.0000 − 1.0000i
1.4142
−1.0000 + 1.0000i

TABLE 7
Step A2-4 of the pre-computation procedure
0.3474 − 0.4193i
0.5000 − 0.5000i
−0.7071
0.5000 + 0.5000i
0.1404 + 0.0291i
−0.5000 + 0.5000i
0.7071
−0.5000 − 0.5000i

As disclosed in step (A2), using the pre-computed local inverted preamble given in Table 7, channel estimation according to the present invention can be performed precisely and efficiently.

The actual channel estimation according to the present invention further requires 5 steps. Namely, the second step (B2) of converting the received preamble sequence further comprises the steps (B2-1) and (B2-2). And, the fourth step (D) of converting the estimate of the propagation channel frequency response to time domain by means of Inverse Fast Fourier Transform further comprises the steps (D2-1) and (D2-2).

For an embodiment, the following section clearly describes each step.

Step B2-1 starts with the SYNC sequence after transmission (i.e. at receive side) as given in Table 8 (see Table 3). Symbols 3 to 10 (symbols are numbered from 1 to 11) are selected for further use.

In Step B2-2, the 8 selected symbols are converted to frequency domain by means of an FFT of dimension 8. The resulting sequence is shown in Table 9.

In Step C2, the 8 frequency domain symbols are multiplied symbol-wise with the local inverted preamble. The resulting sequence is shown in Table 10.

In Step D2-1, the multiplication result is converted to time domain by means of an IFFT of dimension 8. The resulting sequence is shown in Table 11.

In Step D2-2, the estimated impulse response of the multipath propagation channel is shortened to the expected number of taps (1, 2 or 3). The resulting sequence is shown in Table 12. A comparison with

Table 1 confirm the precision of the channel estimation according to the present invention.

TABLE 8
Step B2-1 of the channel estimation procedure
(SYNC Sequence at receiver)
0.8398 + 0.3078i
−1.2281 + 0.2136i
1.2494 + 0.1282i
−1.2281 + 0.2136i
1.2494 + 0.1282i
−1.2281 + 0.2136i
1.2494 + 0.1282i
−0.7928 − 0.9741i
1.0194 + 0.7174i
−1.2281 + 0.2136i
0.7174 − 1.0194i

TABLE 9
Step B2-2 of the channel estimation procedure using the channel
estimation according to the present invention
0.2905 + 0.7686i
−0.0572 + 0.9176i
−0.9577 − 1.0245i
1.7368 − 0.3020i
9.2445 + 1.4353i
−1.1212 − 1.3776i
1.4176 − 0.1539i
−0.5584 + 0.7620i

TABLE 10
Step C2 of the channel estimation procedure using the channel
estimation according to the present invention
0.4232 + 0.1452i
0.4302 + 0.4874i
0.6772 + 0.7244i
1.0194 + 0.7174i
1.2562 + 0.4705i
1.2494 + 0.1282i
1.0024 − 0.1088i
0.6602 − 0.1018i

TABLE 11
Step D2-1 of the channel estimation procedure using the channel
estimation according to the present invention
0.8398 + 0.3078i
−0.4166 − 0.1626i
0.0000 − 0.0000i
0.0000 − 0.0000i
0.0000
0.0000 − 0.0000i
0.0000 − 0.0000i
−0.0000 − 0.0000i

TABLE 12
Step D2-2 of the channel estimation procedure using the channel
estimation according to the present invention
0.8398 + 0.3078i
−0.4166 − 0.1626i

In this section, performance simulation results are presented to demonstrate the successful operation of the present invention. The figure of merit for the demonstration is the bit error rate achieved when using the present invention for obtaining information on the current multipath propagation conditions (i.e. performing channel estimation) as compared to using a-priori knowledge. The channel estimate is used as input for the channel equalization.

In Error! Reference source not found., the bit error rate for 2 Mbps transmission using π/4-DQPSK is shown. As multipath propagation channel, a 2-tap channel is used. The degradation when using the present invention for channel estimation as compared to a-priori knowledge amounts to about 2.5 dB.

In Error! Reference source not found., the bit error rate for 3 Mbps transmission using D8PSK is shown. As multipath propagation channel, a 2-tap channel is used. The degradation when using the present invention for channel estimation as compared to a-priori knowledge amounts to about 2.5 dB.

The degradation in both cases demonstrated is within the typical range of performance degradation introduced by state-of-the-art channel estimation methods. The degradation is mainly introduced by additive white Gaussian noise (AWGN). Further, the present invention is limited by the rather short length of the reference sequence as well as the absence of power-boosting applied to the SYNC sequence at the Bluetooth transmitter.

In state-of-the-art wireless communications systems, reference sequences are typically transmit with an increased power as compared to the actual data. Thus, channel estimation accuracy is increased by estimating the multipath propagation channel using reference data having a higher signal-to-noise ratio than the actual data.

It should be understood that the newly proposed channel estimation method and an apparatus for Bluetooth signals features the following benefits:
1. Outstanding performance of long transmission range Bluetooth service based on power class 1 devices according to the present invention.
2. Potential performance improvement of Bluetooth service based on power class 2 and 3 devices in multipath environment according to the present invention.
3. Low-complexity/high-performance LS-based multipath propagation channel estimator for Bluetooth EDR transmission modes according to the present invention.
4. Highly efficient implementation due to precomputation of local inverted preamble according to the present invention.

The proposed channel estimation method and apparatus according to the present invention enables use of efficient equalization algorithms, therefore mitigating ISI and very successfully estimates propagation conditions while being very implementation-friendly.

Therefore, a new technology especially targets the combined use of channel estimation technology a according to the present invention and channel equalization. It must be noted that the new technology is not limited to any type of channel equalization but can be used in combination with numerous other state-of-the-art channel equalization methods.

Accordingly, the scope of this invention includes, but is not limited to, the actual implementation of the present invention. Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A channel estimation method for Bluetooth signals through a multipath propagation channel, using a SYNC sequence as a preamble sequence, comprising the steps of:
(A) converting a local preamble sequence before the SYNC sequence transmitting through the multipath propagation channel to frequency domain by means of Fast Fourier Transform;
(B) converting the received preamble sequence after the SYNC sequence transmitting through the multipath propagation channel to frequency domain by means of Fast Fourier Transform;
(C) dividing the received frequency domain preamble by the local frequency domain preamble to yield an estimate of the propagation channel frequency response; and
(D) converting the estimate of the propagation channel frequency response to time domain by means of Inverse Fast Fourier Transform.

2. The channel estimation method as claimed in claim 1, wherein the first step (A) further comprises the step of converting the local preamble sequence to be a the local inverted preamble sequence, and the third step (C) is modified to be multiplying the received frequency domain preamble with the local inverted frequency domain preamble to yield an estimate of the propagation channel frequency response.

3. The channel estimation method as claimed in claim 2, wherein the first step of converting the local inverted preamble further comprises the steps of:
(A-1) selecting 8 out of 11 preamble time domain symbols of the SYNC sequence;
(A-2) reshuffling the selected symbols;
(A-3) performing an Fast Fourier Transform of dimension 8 on the reshuffled symbols; and
(A-4) inverting the 8 frequency domain symbols to obtain the local inverted preamble.

4. The channel estimation method as claimed in claim 2, wherein the second step of converting the received preamble sequence further comprises the steps of:
(B-1) selecting 8 out of 11 received preamble (time domain) symbols; and
(B-2) performing an Fast Fourier Transform of dimension 8 on the selected symbols.

5. The channel estimation method as claimed in claim 2, wherein the fourth step of converting the estimate of the propagation channel frequency response to time domain by means of Inverse Fast Fourier Transform further comprises the steps of:
(D-1) performing an Inverse Fast Fourier Transform of dimension 8 on multiplication result of the step (C); and
(D-2) shorting the estimated channel impulse response.

6. The method as claimed in claim 1, wherein the method is combined with any type of channel equalization to migrate the inter-symbol interference.

7. A channel estimation apparatus for Bluetooth signals, through a multipath propagation channel, using a SYNC sequence as a preamble sequence, mainly comprising:
(A) means for converting a local preamble sequence before the SYNC sequence transmitting through the multipath propagation channel to frequency domain by means of Fast Fourier Transform;
(B) means for converting the received preamble sequence after the SYNC sequence transmitting through the multipath propagation channel to frequency domain by means of Fast Fourier Transform;
(C) means for dividing the received frequency domain preamble by the local frequency domain preamble to yield an estimate of the propagation channel frequency response; and
(D) means for converting the estimate of the propagation channel frequency response to time domain by means of Inverse Fast Fourier Transform.

8. The channel estimation apparatus as claimed in claim 7, wherein the first means (A) is further used for converting the local preamble sequence to be a the local inverted preamble sequence, and the third mean (C) is modified to be used for multiplying the received frequency domain preamble with the local inverted frequency domain preamble to yield an estimate of the propagation channel frequency response.

9. The channel estimation apparatus as claimed in claim 8, wherein the first means for converting the local inverted preamble converts the local inverted preamble further comprises the steps of:
(A-1) selecting 8 out of 11 preamble (time domain) symbols of the SYNC sequence;
(A-2) reshuffling the selected symbols;
(A-3) performing an Fast Fourier Transform of dimension 8 on the reshuffled symbols; and
(A-4) inverting the 8 frequency domain symbols to obtain the local inverted preamble.

10. The channel estimation apparatus as claimed in claim 8, wherein the second means for converting the received preamble sequence converts the received preamble sequence further comprises the steps of:
(B-1) selecting 8 out of 11 received preamble (time domain) symbols; and
(B-2) performing an Fast Fourier Transform of dimension 8 on the selected symbols.

11. The channel estimation apparatus as claimed in claim 8, wherein the fourth means for converting the estimate of the propagation channel frequency response to time domain by means of Inverse Fast Fourier Transform converts the estimate of the propagation channel frequency response further comprises the steps of:
(D-1) performing an Inverse Fast Fourier Transform of dimension 8 on multiplication result of the step (C); and
(D-2) shorting the estimated channel impulse response.

12. The channel estimation apparatus as claimed in claim 7, wherein the apparatus is combined with any type of apparatus of channel equalization to migrate the inter-symbol interference.
